(19) United States
(12) Patent Application Publication
(10) Pub. No.: US 2009/0153871 A1
(43) Pub. Date: Jun. 18, 2009

(54) Combination lightwave antenna and spectral analyzer and methods

(76) Inventors: Eric Dean Rosenthal, Morganville, NJ (US); Richard Jay Solomon, Monson, MA (US); Clark Eugene Johnson, Waunakee, WI (US)

Correspondence Address: ERIC ROSENTHAL, 191 BEACON HILL ROAD, MORGANVILLE, NJ, 07751-4208, US

(21) Appl. No.: 12/157,503

(22) Filed: Jun. 11, 2008

Related U.S. Application Data
(60) Provisional application No. 60/934,328, filed on Jun. 12, 2007.

(51) Int. Cl. G01J 3/45

(52) U.S. Cl. 356/451

(57) ABSTRACT

The present invention relates to sensor apparatus and methods, pertinent to electromagnetic energy in visible and other spectra, to capture and reproduce substantially all electromagnetic information within a relevant spectrum.

This invention takes advantage of the wave properties of light, using tiny components dimensioned to the relevant wavelengths of light. Recent developments in nano-technology permit construction of wave-based detectors, instead of photon-counting receivers. These wave detectors can operate in the electromagnetic spectral range, including submillimeter, infrared, visible, ultraviolet and X-ray bands, with consequent low noise and tremendous sensitivity due to gain resulting from their inherent antenna construction. This invention provides for both non-contact and contact coupling methods between the sensor and the receiver/demodulator.

The present patent application claims priority from our provisional application Ser. No. 60/934,328 filed on 12 Jun. 2007. That application is hereby incorporated herein by reference.

### TECHNICAL FIELD AND BACKGROUND ART

The present invention relates to sensor devices and methods, pertinent to electromagnetic energy in visible and other spectra, to capture and reproduce substantially all electromagnetic information within a relevant spectrum. That invention permits such sensors to couple its output signal without necessarily utilizing a wired connection.

The information in the electromagnetic regions of the spectrum contains a rich data set that includes phase, frequency, polarization, and intensity that cannot be extracted and captured directly via conventional photonic sensors.

It is known in the art that heterodyning can be used for detecting the spectral composition or spectral signature of complex infrared electromagnetic waveforms. In this technique, “an infrared source is combined with a laser local oscillator,” in the manner described by Kostiuk (see reference), “and focused on an infrared photometer, where the difference frequency between the source and laser frequencies is generated . . . . The resultant intermediate frequency . . . is in the radio region of the electromagnetic spectrum and it preserves the intensity and spectral information of the infrared spectrum . . . .”

Devices using this invention capture and process electromagnetic energy, including submillimeter, infrared, visible, ultraviolet and X-ray bands, with each pixel serving as a full-spectrum, wide-ranging, ultra-high-resolution spectrometer. Such a sensor is a radical departure from conventional photon-counter devices in that it is capable of detecting the full range of information contained in an object beyond that of filter-constrained color spaces due to absorption filtration, and in addition, this invention captures phase and polarization data.

FIG. 1 compares existing photonic systems working in the amplitude domain with this invention, electromagnetic wave antenna arrays, working in the frequency domain. Photonic systems cannot detect large amounts of original object information, restricting downstream analysis to primarily interpretations of energy received. Electromagnetic wave sensors, capturing narrowband frequency and phase information, can take advantage of the extensive processing capability of Fourier transform processing.

### SUMMARY OF THE INVENTION

Embodiments of this present invention take advantage of the wave properties of light, and therefore use tiny components dimensioned to the wavelengths of light. Recent developments in nano-technology permit construction of wave-sensitive receivers, instead of photon-sensitive devices. These receivers can operate in the light range of the electromagnetic spectrum, including adjacent infrared and ultraviolet bands, with consequent low noise and tremendous sensitivity due to gain resulting from their inherent antenna construction. This invention provides for both non-contact and contact coupling methods between the sensor and the receiver/demodulator.

In a preferred embodiment of the invention there is provided a sensor module, using nano-technology, consisting of a double-spiral antenna formed on a non-linear substrate. The electromagnetic waves resonate within the nano-technology-scaled spirals acting as antennas. The non-linear substrate enables mixing the re-radiating signal from the substrate with a local oscillator reference signal such that a heterodyned radio-frequency (RF) output is produced for reception and demodulation at the lower frequency band using RF technology as known in the art. In this embodiment, there is no physical connection between the sensor module and the baseband receiver/demodulator for detecting the heterodyned RF signal. A heterodyne detecting antenna is provided to capture the heterodyned baseband mixing product re-radiated RF signal and feeds it to the intermediate frequency (IF) receiver/demodulator.

In other embodiments of the invention, adjusting the construction, architecture, geometry and parameter size of the antennas enable them to sense electromagnetic energy ranging from the submillimeter waveband, through infrared, visible light, to ultraviolet and X-rays.

Another embodiment of this invention teaches the construction of an array for color imaging without the necessity of using conventional absorption bandpass filters to separate frequency bands. An essential ingredient for such a light-range wave-sensitive receiver is the ability to fabricate antennas with the dimensions of the wavelength of light. These antennas incorporate high signal-to noise properties and gain at the wavelengths to be detected.

In another embodiment, the sensor module collects energy from an object and a reference signal, mixes the signals, and creates a heterodyne derived output that is coupled to an IF demodulator—all without direct electrical connections. The re-radiating high-gain antenna element coupled to the sensor module works strictly on wave detection and wave re-radiation, without direct electrical connections.

One embodiment of this invention reduces the size of an electromagnetic wave antenna so that it contains elements designed to resonate with wavelengths that cover the visible light range of the electromagnetic spectrum. There are various architectures that may be used for such antennas. For example, it is known in the prior art that an antenna shaped as a helical tapered cone acts as a frequency analyzer, resonating at specific wavelengths depending upon the taper's cross-sectional dimensions. In other embodiments, this element may be a Yagi antenna resonant at the RF of the heterodyne signal, a helical circularly-polarized antenna, or a helical resonator.

In other embodiments of the invention there is provided, using nano-technology, an array of antennas. This array may be grouped into clusters with elements of the array having different lengths covering the range of frequencies being swept by the local oscillator. The arrays may employ phased array processing.

### BRIEF DESCRIPTION OF THE DRAWINGS

The foregoing features of the invention will be more readily understood by reference to the following detailed description, taken with reference to the accompanying drawings, in which:

FIG. 1 compares existing photonic systems working in the amplitude domain with this invention, electronic lightwave arrays, working in the frequency domain.

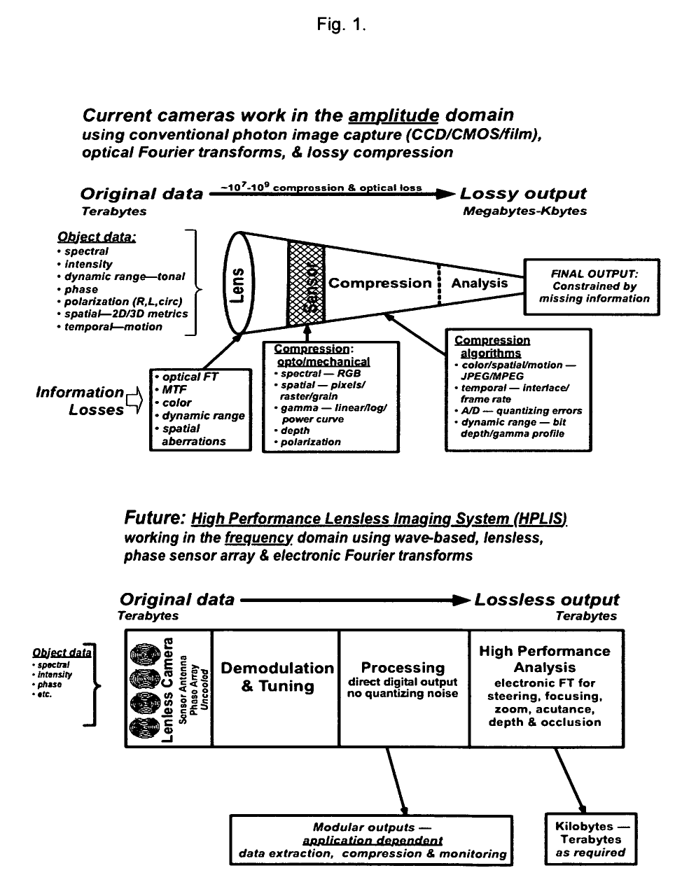

FIG. 2 is the geometry of a two-armed planar spiral antenna.

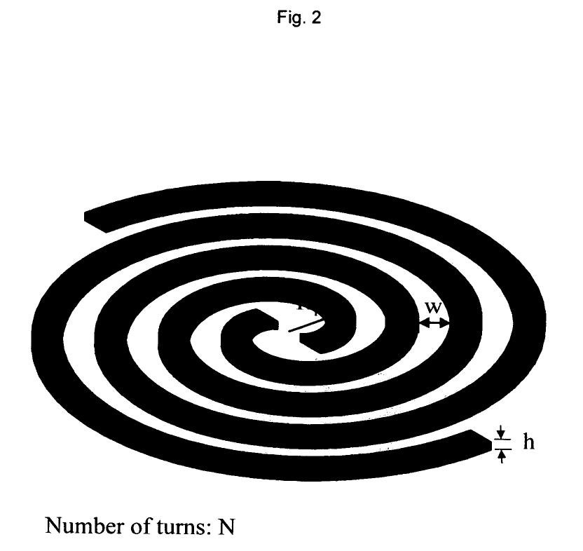

FIG. 3 illustrates a preferred embodiment for a lightwave antenna utilizing a double-spiral nano-antenna formed on a non-linear re-radiating substrate and heterodyned RF output coupled via an antenna connected to an RF demodulator/receiver.

### DETAILED DESCRIPTION OF SPECIFIC EMBODIMENTS

### Definitions

As used in this description the following terms shall have the meanings indicated unless the context otherwise requires:

“Heterodyning” is the combining of two sinusoidal electromagnetic waves in a non-linear material giving a consequent mixing product of sum and difference frequencies.

“Electromagnetic imaging coupling substrate” is the non-linear material that provides the heterodyning means.

“Demodulator” is a device that extracts information from the changing characteristics of an input electromagnetic wave.

“Reference signal” is the local oscillator (sinusoidal electromagnetic wave) for heterodyning.

“Yagi antenna” is a multi-dipole antenna structure that provides directionality and gain.

“Helical resonator” is a spirally-wound conductor located inside a conducting container that produces or detects single-lobe circularly polarized electromagnetic waves.

“Intermediate Frequency” is the resultant mixing product difference frequency output of a heterodyne mixer.

“Lightwave” is electromagnetic energy in the portion of the electromagnetic spectrum including submillimeter, infrared, visible, ultraviolet and X-rays.

“Radio Frequency” is the electromagnetic spectrum below 300 Gigahertz.

“Submillimeter Waves” is the electromagnetic spectrum from 1 Terahertz through 3 Terahertz.

The present application contains subject matter related to that in patent application Ser. No. 10/999,741, filed Nov. 30, 2004, concerning Electromagnetic spectral-based imaging devices and methods, invented by us; and U.S. Pat. No. 6,985,294, relating to a full-spectrum projector device invented by us; these patent documents are hereby incorporated herein by reference.

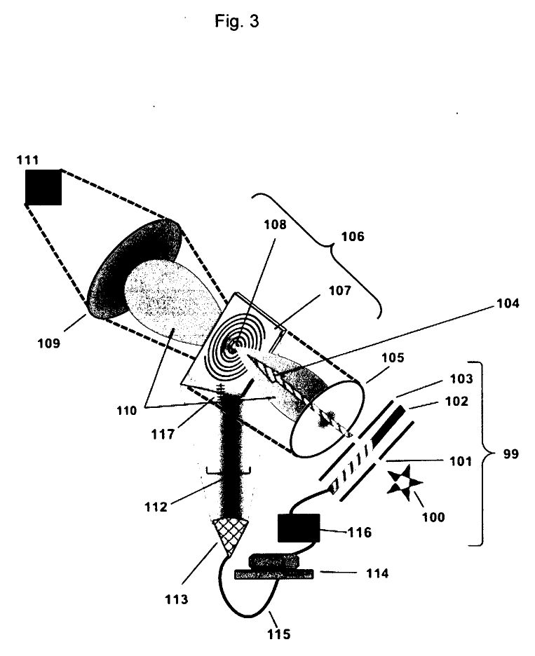

FIG. 3 illustrates a preferred embodiment for a single, wave-based nanoscale sensor that detects lightwave energy, implementing heterodyning for detection and demodulation. In this embodiment the antenna element is a double-spiral to reduce common mode interference. There is no physical connection between the detecting antenna element and the demodulator component. This method of detection reduces loading effects on the sensor module.

Electromagnetic energy in the visible portion of the spectrum from object 111 is directed to antenna element 108 by lens 109. The frequency of this energy is detected by the following method: controlled variable light-frequency sweep oscillator 99 generates a reference signal for heterodyning (a “local oscillator,” as is known in the art) by full-spectrum, coherent light source 100 passing collimated light through narrow slit 101 which energy is then separated into its spectral components via diffraction grating 102. Grating 102 is positioned by being mounted on a deformable substrate. Grating 102's output passes through second slit 103 which selects a very narrow frequency, occluding all other frequencies. This selected frequency, 104, functions as a reference signal. This reference 104 is focused via lens 105 onto sensor module 106. The sensor module consists of electromagnetic imaging coupling substrate 107 embedding nanoscale, double-spiral antenna 108. At this nanoscale, the double-spiral antenna's polar receiving patterns 110 emanate from both the front and back sides of the sensor module 106. The sensor module's substrate 107 is comprised of a non-linear element, which enables heterodyne mixing. Substrate 107 includes high-gain directional antenna 117, resonant at the heterodyne mixing product intermediate frequency 112, which is directed to receiving antenna 113. In this embodiment there is no physical connection between antenna 113 and antenna 117.

The frequency of reference signal 104 is determined by a signal from receiver/demodulator 114, controlled via spectrum analyzer/controller 116, sent to grating 102. This signal thereby positions grating 102 which causes only the selected frequency of reference signal 104 to pass through slit 103.

The light energy from object 111, received at antenna 108, energizes non-linear substrate 107 which mixes with energy from reference signal 104. Antenna 117 thereby radiates IF 112. Antenna 113 receives IF 112 which is connected via cable 115 to demodulator 114.

The reference signal 104 is swept across a range of frequencies by a voltage delivered via spectrum analyzer/controller 116 actuated by its internal clock. When controller 116 detects a signal from demodulator 114 the controller 116 gates an output from its internal clock that is directly related to the frequency of the electromagnetic energy from object 111. Controller 116 simultaneously receives the analog output of demodulated IF signal 112 from receiver 114. This latter process gates an analog/digital converter, accomplished via slope detection to eliminate quantizing error, as known in the art, to define the analog amplitude of the source signal from object 111. Therefore, the amplitude of demodulated signal 112 and reference frequency 104 together define a specific spectral characteristic of object 111, the instantaneous frequency and intensity.

The heterodyne mixing product 112 is the difference of the two input signals: reference signal 104 and energy 110 from the image 111. The mixing product, for example, may be an intermediate frequency of 2 GHz.

In a related embodiment, high-gain directional antenna 117 is a Yagi antenna resonant at the IF, directing its energy towards receiving antenna 113. Antenna 117 may be vertically or horizontally polarized to match the polarization of receiving antenna 113.

In a related embodiment, high-gain directional antenna 117 is a helical circularly-polarized antenna resonant at the intermediate frequency, directing its energy towards a similarly circularly polarized resonant antenna 113 resonant at the intermediate frequency. Polarization acts as a filtering mechanism attenuating interfering signals which are not similarly polarized, thereby increasing the signal-to-noise ratio.

In a related embodiment, high-gain directional antenna 117 is a helical resonator.

In a related embodiment, antenna 113 is a helical resonator.

In a related embodiment, full-spectrum coherent light source 100 is a femtosecond laser white light continuum.

In another embodiment, the local oscillator is the Full-Spectrum Projector device as described in U.S. Pat. No. 6,985,294, programmed to sweep the spectrum in narrow increments.

In another embodiment, diffraction grating 102 is mounted on a piezo-electric substrate for positioning.

In another embodiment, antenna 117 is a 2 or 3 dimensional array of antennas dimensioned and spaced to act as an antenna array that directs the IF energy towards antenna 113.

In a further related embodiment of the present invention the antenna elements in the array may be grouped into clusters. Each cluster is designed to cover a range of frequencies, and therefore each antenna element in the cluster may have a different length. The actual detected bandwidth is determined by the variation in the lengths of the antennas in the cluster. Each cluster in turn may be designed to cover a distinct frequency range and may also employ phased array processing.

Other embodiments of the present invention use antenna elements, non-linear substrates, and diffraction gratings dimensioned to detect and analyze electromagnetic energy in the submillimeter wave, infrared, ultraviolet and X-ray ranges.

In another embodiment the substrate is resonant at the intermediate frequency.

In another embodiment the spiral antenna has a tapered pitch. The taper follows a function that allows for the antenna to resonate within the band that is swept.

### REFERENCES

Kostiuk, T. “Heterodyne Spectroscopy in the Thermal Infrared Region: A Window on Physics and Chemistry,” NASA Goddard Space Flight Center, Proceedings of the International Thermal Detectors Workshop, Jun. 19-20, 2003, on web at http://lep694.gsfc.nasa.gov/code693/tdw03/proceedings/start.html

What is claimed is:

1. A combination lightwave antenna and spectral analyzer comprising:
a non-linear reradiating substrate;
a nanoscale antenna, mounted on the substrate for receiving lightwave frequencies,
so that a radio frequency heterodyne signal resulting from a difference of a suitable lightwave reference signal received by the antenna with lightwave energy received by the antenna from an object is reradiated by the substrate.

2. A system for analyzing spectral characteristics of lightwaves of an object, the apparatus comprising:
a non-linear reradiating substrate;
a nanoscale antenna, mounted on the substrate for receiving lightwaves from the object;
a variable electromagnetic lightwave frequency sweep local oscillator providing a swept reference signal output, wherein the reference signal output is directed toward the antenna so as to mix with the lightwaves from the object,
so that a radio frequency heterodyne signal resulting from a difference of the swept reference signal output received by the antenna with lightwaves received by the antenna from an object is reradiated by the substrate.

3. A system according to claim 2 further comprising:
a receiving antenna, physically distinct from the substrate module, and positioned to receive the radio frequency heterodyne signal;
a high-gain directional antenna, coupled to the substrate, that directs the radio frequency heterodyne signal toward the receiving antenna;
a receiver/demodulator, coupled to the receiving antenna, for providing an output signal responsive to the spectral characteristics of lightwaves of an object.

4. A system according to claim 2, wherein the variable lightwave frequency sweep local oscillator comprises:
a full-spectrum, coherent light source generating collimated light;
a narrow slit coupled to a diffraction grating, such component separating the electromagnetic lightwave energy into its spectral components;
a second slit selecting a very narrow electromagnetic lightwave frequency as specified by the spectrum-analyzer.

5. A system according to claim 2, wherein the diffraction grating is mounted on a piezo-electric substrate for positioning, the piezo electric substrate controlled by a spectrum-analyzer controller.

6. A system according to claim 2, wherein the full spectrum coherent light source includes a femtosecond laser.

7. A system according to claim 2, wherein the variable lightwave frequency sweep local oscillator is programmed to sweep the spectrum in narrow increments.

8. A system according to claim 2, wherein the high-gain directional antenna is a Yagi antenna resonant at the radio frequency of the heterodyne signal.

9. A system according to claim 2, wherein the high-gain directional antenna is a helical circularly-polarized antenna.

10. A system according to claim 2, wherein the high-gain directional antenna is a helical resonator.

11. A system according to claim 2, wherein the high-gain directional antenna is a spiral antenna with a tapered pitch, such taper following a function such that the antenna resonates within the electromagnetic band being swept by the local oscillator.

12. A system according to claim 2, wherein the directional antenna and the receiving antenna are structured as arrays of antennas, such arrays dimensioned and spaced to direct and detect the intermediate frequency energy.

13. A system according to claim 12, wherein the directional array and the receiving array are grouped into cluster elements, and such elements having different lengths covering a range of frequencies being swept by the local oscillator.

14. A system according to claim 12, wherein the arrays employ phased array geometry.

15. A system according to claim 2, wherein the substrate is resonant at the heterodyne signal frequency.

16. A system according to claim 2, wherein components of the system are dimensioned to detect and analyze electromagnetic energy in at least one of the submillimeter, infrared, visible, ultraviolet, and X-ray ranges.

17. A method of analyzing the spectral characteristics of a lightwave, the method comprising:
providing a non-linear reradiating substrate on which is mounted a nano-scaled antenna, using the nano-scaled antenna for receiving the lightwaves from the object;
directing a swept reference signal toward the antenna so as to mix with the lightwaves from the object,
so that a radio frequency heterodyne signal resulting from a difference of the swept reference signal received by the antenna with the lightwaves received by the antenna from the object is re-radiated by the substrate, and
receiving and demodulating the radio frequency heterodyne signal to provide an output signal responsive to the spectral characteristics lightwaves of the object.

18. A method according to claim 17, wherein the electromagnetic energy of lightwaves are in at least one of the submillimeter, infrared, visible, ultraviolet, and X-ray ranges.

19. A method according to claim 17, wherein an array of antennas employs phased array processing.
